(19) United States
(12) Patent Application Publication
(10) Pub. No.: US 2010/0301658 A1
(43) Pub. Date: Dec. 2, 2010

(54) SAFETY DEVICE TO SECURE A CHILD SEAT TO THE VEHICLE SEAT

(75) Inventors: Alejandro Furas, Montevideo (UY); Martha Warren Bidez, Birmingham, AL (US); Donald S. Burke, III, Trussville, AL (US)

Correspondence Address: Leason Ellis LLP, 81 Main Street, Suite 503, White Plains, NY, 10601, US

(73) Assignee: FUNDACION GONZALO RODRIGUEZ, Montevideo (UY)

(21) Appl. No.: 12/787,951

(22) Filed: May 26, 2010

(30) Foreign Application Priority Data
May 27, 2009 (UY) U-4281

(51) Int. Cl. B60N 2/44

(52) U.S. Cl. 297/463.1

(57) ABSTRACT

A device to secure a child seat to a vehicle's seat comprises of a piece of webbing to which two fixed pieces are attached, one to each end, and a movable piece that runs freely along the piece of webbing. The device secures the child seat to the bodywork/frame of the vehicle and to the seat, regardless of the vehicle's model.

### FIELD OF THE INVENTION

This invention is a vehicle safety device. More specifically, it is an example of devices that secure child seats to the vehicle seat.

### BACKGROUND OF THE INVENTION

Child seats are normally secured to the vehicle seat by a seat belt. These types of child seats need, however, a device that allows securing them by their upper part.

Several solutions to secure child seats to the vehicle seat have been proposed in the prior art. The following are some examples,

U.S. Pat. No. 4,685,740 uses a three-point seat belt together with a traction device; the seat belt restrains both the seat and the child.

Publication EP0331299 proposes a system to secure the seat through the use of an adult seat belt on the upper part of the seat on one hand, and on the other a metallic piece attached to the seat belt anchor and a pivotal base attached to the child seat base.

U.S. Pat. No. 4,854,639 proposes a child seat with a 3-point seat belt restraining both, the child and the seat, preventing movement in case of sudden deceleration. A similar restraint system is used in request FR2735001.

Publication US20020175545, a system with two guides on a seat belt attached to the vehicle structure. A drawback of this system is its little control on the child seat's upper part.

Publication US20060163923 relates to a 3-point seat belt system with a traction device connecting the child seat to ordinary attachment points in the vehicle.

All these child seat restraint systems may vary, but they all have one common drawback: there is little control on the upper part of the child seat, where the child's head is positioned. Besides, it is always necessary to secure the upper part of the child seat as a way of preventing its forward projection in case of sudden deceleration.

Child seats are currently standardly manufactured with a piece of webbing with an adjustment system, said webbing strap secures the upper part of the child seat using a hook.

The seat is secured by the webbing strap that connects its upper part, through the use of a device in the shape of a hook, with the frame of the vehicle; the lower part of the child seat is normally secured by a 2 or 3-point seat belt. By doing this a better control of the upper part of the seat is achieved, preventing sudden child's head movements in case of sudden deceleration.

The problem with current child seats is that not all vehicles have devices to allow the attachment of the hook in the upper part of the child seat to the vehicle's frame. Besides, it is not always easy to have a device installed in a vehicle to which the webbing strap of the upper part of the child seat can be attached. This makes it difficult to secure child seats complying with all safety requirements.

It is then necessary to find a device versatile enough to allow securing child seats to the vehicles regardless of the model and complying will all safety requirements.

### SUMMARY OF THE INVENTION

To provide a simple device that allows a child seat to be fastened to any kind of vehicle seat while complying with all international safety regulations.

### BRIEF DESCRIPTION OF THE DRAWING FIGURES

FIG. 1 shows a child seat without any piece of webbing connected to its upper part according to prior art.

FIG. 2 shows a child seat with a piece of webbing connected to its upper part but unattached to the vehicle, also according to prior art.

FIG. 3 represents a plan view form above of a device according to the invention.

FIG. 4 shows a side plan view of a device according to the invention

FIG. 5 represents a front plan view of a movable piece of the invention device.

FIG. 6 represents an isometric perspective view of a movable piece of the invention device.

FIG. 7 shows an isometric perspective view of a device according to the invention.

FIG. 8 shows a plan view from above of a device according to the invention.

FIG. 9 shows a side plan view of a device according to the invention.

FIG. 10 shows a front plan view of a movable piece in the device according to the invention device.

FIG. 11 represents an isometric perspective view of a movable piece of the invention device.

FIG. 12 shows an isometric perspective view of a device according to the invention.

FIG. 13 shows a plan view of an attachment system of the invention device.

FIG. 14 shows the invention device already installed in a vehicle.

FIG. 15 is a photo of the invention device showing what it would look like once installed.

### DETAILED DESCRIPTION OF CERTAIN EMBODIMENTS OF THE INVENTION

The invention safety device consists of a piece of webbing which has three attachment components. Each component consists of a piece with one or more through holes. Two of the three attachment components mentioned are fixed to each of the webbing ends and the third one is a movable component that can move freely along the piece of webbing, and, more specifically, along an intermediate portion of the webbing between the respective ends thereof.

The piece of webbing is conventionally attached to the fixed components (i.e. passing the end of the piece of webbing through a slot in each of the fixed components and sewing, riveting or sticking it, using a suitable adhesive, to the same piece of webbing. The movable component may have any conventional component that lets it freely run along the piece of webbing, for example a through slot.

Fixed and movable pieces can have any shape as well as their through holes. However, those of rectangular or circular cross section are preferred.

The invention device allows connecting the child's seat upper webbing strap to the frame/bodywork of any vehicle with seat belt connections in such a way that the child seat is secured to the vehicle seat.

To do this, each of the device's fixed components is attached to each of the two elements (screws, bolts, etc.) securing each end of the vehicle seat belt to the bodywork/frame, and the movable component moves along the webbing strap until it reaches a position in which it connects to the upper webbing strap of the child seat.

It should be noted that the invention device needs to be connected to the two elements securing the seat belt to the vehicle's bodywork only once. Also, the device can be used in any kind of vehicle because all vehicles have two elements to secure the seat belt to the bodywork.

The device could also be used in any kind of vehicles other than cars as long as they have safety elements to attach the seat belt to the vehicle's floor. Whether a child can be transported or not in such a vehicle will be determined by safety regulations.

Drawings are now provided to make understanding easier. Drawings should be considered preferred embodiments, not representing in any way a limitation to the invention's scope.

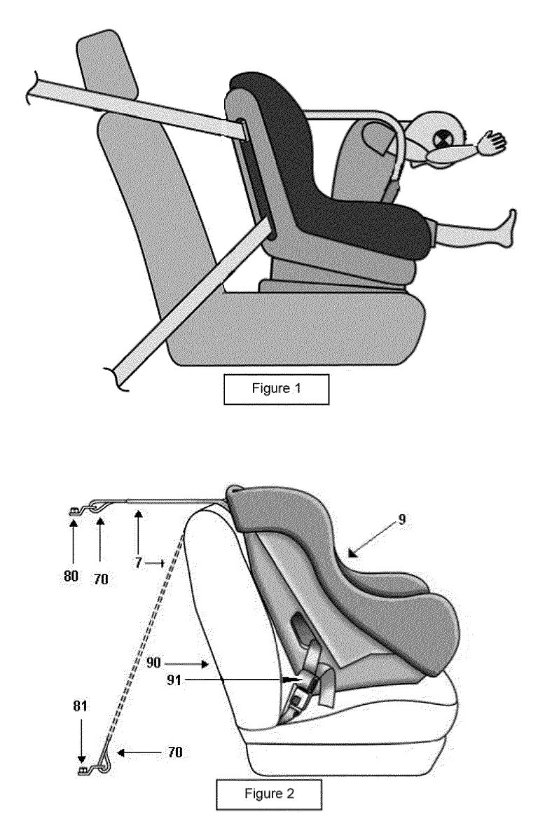

FIG. 1 is a prior art realization in which a child seat was secured by means of a conventional 3-point seat belt without an attachment webbing strap on the upper part of the child seat. It should be noted that, in case of sudden deceleration, there is a significant movement forward of the child seat and body.

FIG. 2 also shows a prior art realization, in which the webbing strap 7 is attached to the child seat's upper part 9 it may connect to a point 80 on the frame directly behind the vehicle seat 90 or to a point 81 on the vehicle's bodywork/frame behind the car's seat through a hook/coupling 70; a conventional 3-point seat belt 91, secures the lower part of the child seat to the vehicle's floor. This system solves the problem mentioned in the paragraph above. The drawback of this system is that not all vehicles have said hooks or points on the bodywork/frame to allow the installation of said hooks complying with safety requirements.

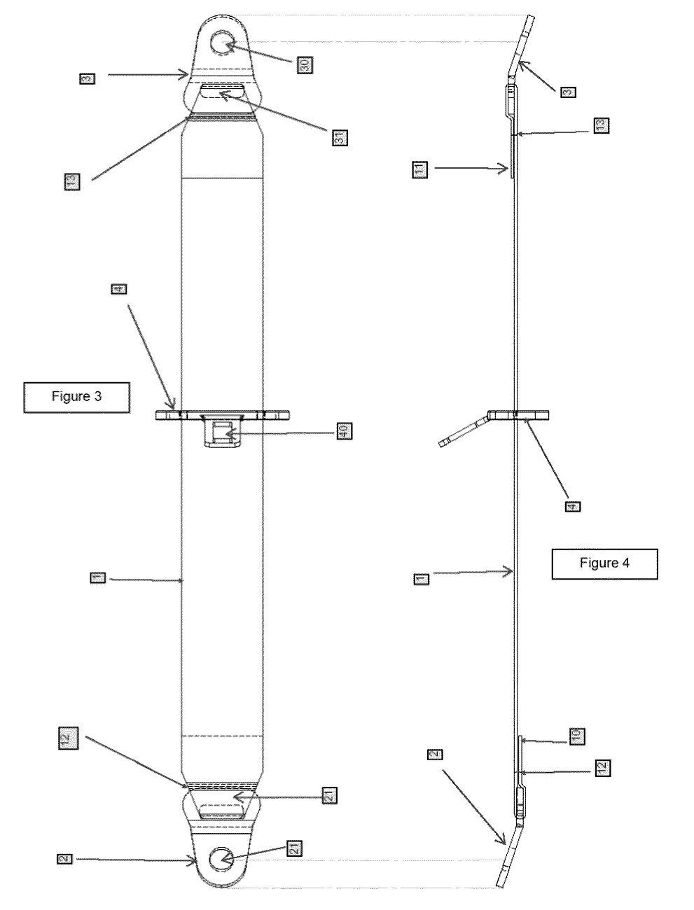

FIG. 3 illustrates a plan view from above of the present invention device. The device is made up of a piece of webbing 1 connected in both ends to two fixed attachment pieces 2, 3, and with a movable attachment piece 4 that can move along the webbing strap 1. Piece 2 has a through hole 20 through which seat belt's attachment elements on the vehicle floor secure it (bolt, nuts, etc). There is also a slot 21 that enables the webbing strap 1 to be pulled through and secured.

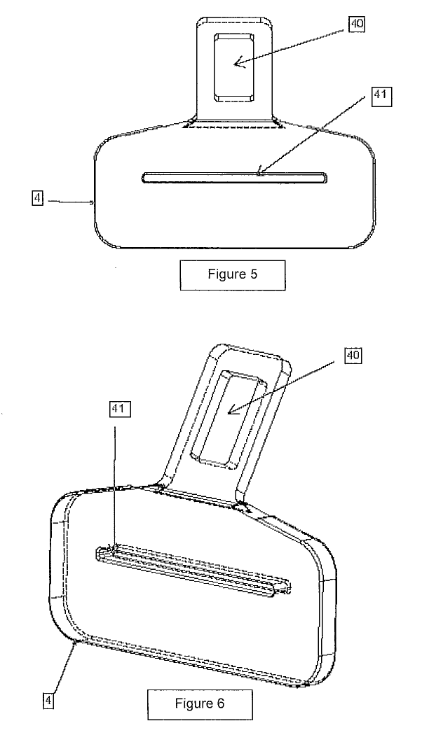

FIG. 4 is a side plan view of realization in FIG. 3. Fixed pieces 2 and 3 are curved in opposing directions in relation to the webbing's surface 1. The movable piece 4 has its upper part inclined/bent to one side. The webbing's 1 folded areas 10, 11 can be more easily seen, as well as the seams 12, 13.

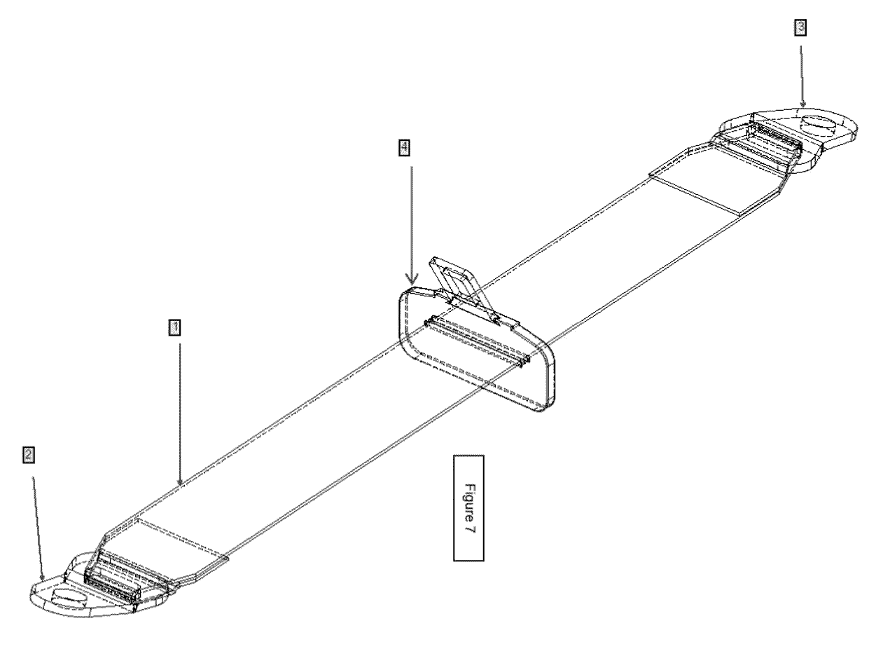

FIG. 5 shows a detailed view of the movable piece 4 in which the through slot 41 can be seen, for the piece to run along the webbing strap 1. FIG. 6 is an isometric projection of piece 4.

FIG. 7 shows the isometric projection of invention device in FIG. 3. It shows the webbing strap 1, fixed pieces 2, 3, and movable piece 4.

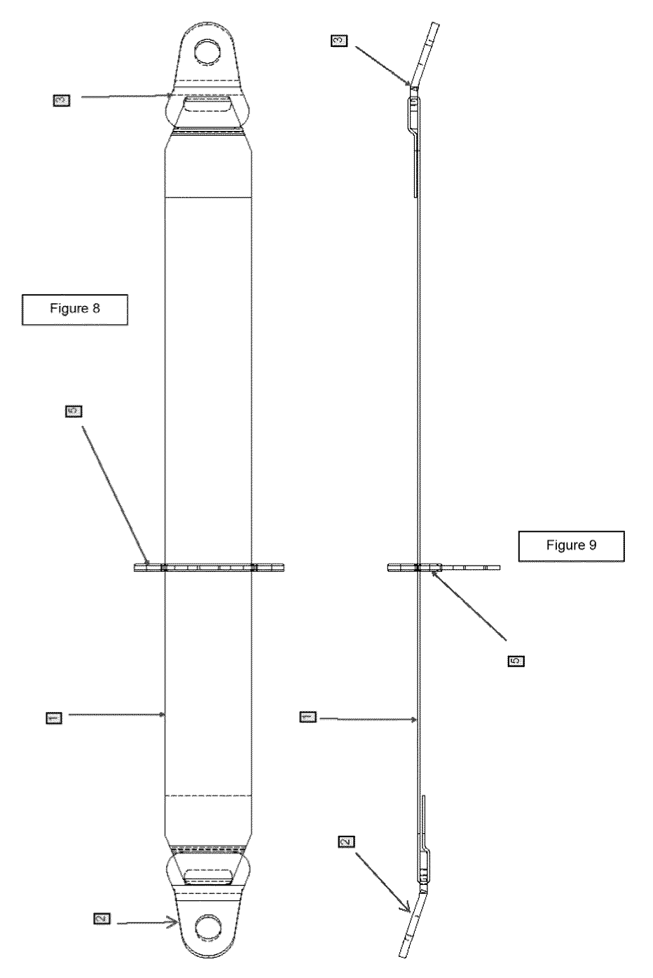

FIG. 8 is a plan view from above of another invention device realization. The difference in this case, is in the movable piece 5, which contrary to the case of piece 4 shows no inclination. FIG. 9 is a side plan view of the device in FIG. 8.

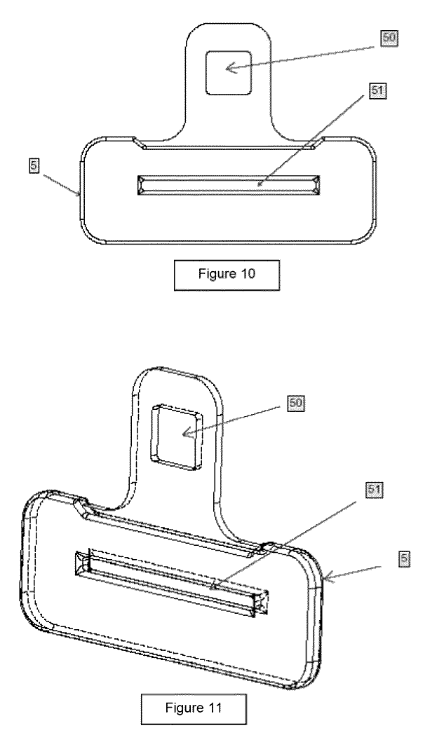

FIG. 10 is a detailed view of piece 5, where the through hole 50 and slot 51 can be seen, this allows piece 5 to run along the webbing strap 1. FIG. 11 is an isometric projection of piece 5.

FIG. 12 is an isometric projection of device in FIG. 8, showing the webbing strap 1, fixed pieces 2, 3, and the movable piece 5.

FIG. 13 is a detailed view of a potential attachment system for the device through the same bolts used for securing the seat belt to the vehicle's bodywork or frame. Piece 2 is attached to the bodywork/frame through aperture 20 through a bolt 6 together with a washer 60 and bushing 61.

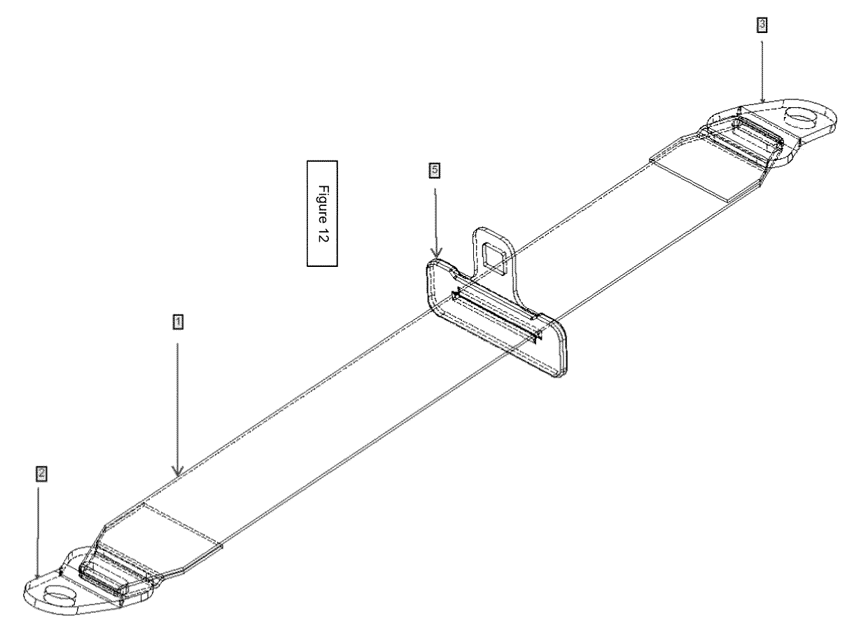

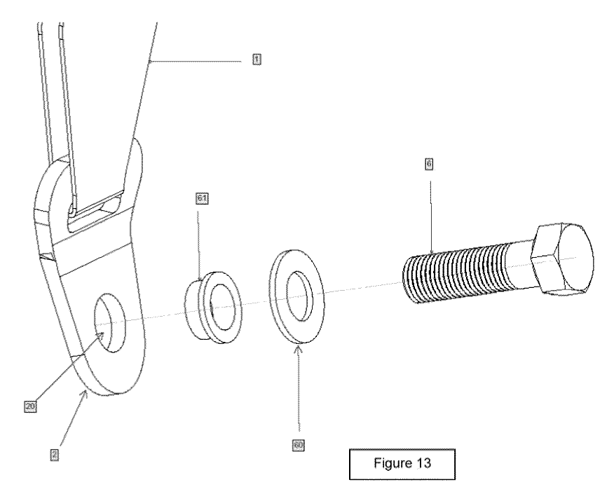

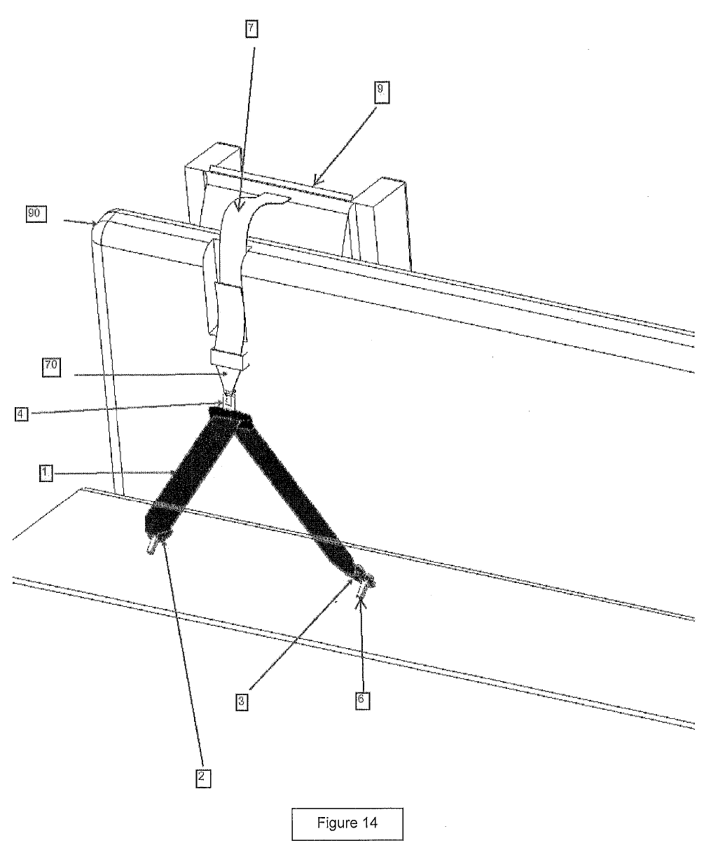

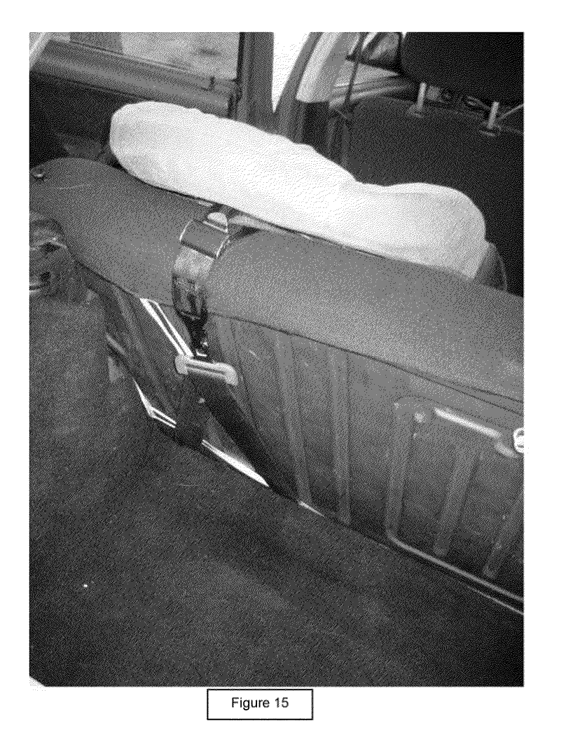

FIG. 14 shows the device in FIG. 3 already installed in the vehicle. The device is attached to the webbing 7 of the child seat 9 through the movable hook 4. On the other hand, fixed pieces 2, 3 are attached to the bodywork/frame through the bolts 6. This arrangement allows to keep the upper part of the child seat 9 secured to the vehicle seat 90. By doing this, in case of sudden deceleration, the upper part of the child seat will not move forward. Since bolts 6 used are the same that secure the seat belt to the bodywork/frame, the device can be installed in any vehicle, without any special arrangement.

FIG. 15 is a photography that shows an installed device according to the invention. A device was set up only for the photograph to be taken. The movable piece is connected to the hook on the webbing strap on the upper part of the child seat. The fixed pieces (not shown in the photograph), on the other hand, are attached to the bodywork/frame, on the same attachment points used for the seat belt.

As the expert will know, the fixed pieces in the device may be in any shape as long as said shape is suitable for securing the pieces to the vehicle's bodywork/frame, the movable piece may also be in any shape as long it allows the appropriate connection to the hook on the webbing strap on the upper part of the child seat. The fixed pieces can be in the same or different shapes.

The webbing may be made of any material that complies with safety regulations. Most recommended are webbing straps made of polyamide (Nylon), aramid (Kevlar) or polypropylene. Those made of polyamide and aramid are among those strongly recommended.

Attachment pieces, either fixed or movable may be made of the same or different materials. Although all materials should comply with safety requirements, metallic materials, especially stainless steel and aluminum alloys, are preferred.

The expert should also note that since this is a safety device for child seats, it should comply with safety requirement set by on-going standards.

1. A device for securing a child seat to a vehicle seat, comprising:
a webbing strap having webbing ends and an intermediate portion; and
three attachment components coupled to the webbing strap, each component comprising a piece with one or more through holes,
wherein a first and second of the three attachment components are fixed to each of the webbing ends and wherein a third of the three attachment components is movably mounted for free movement along the intermediate portion of the webbing strap.

2. The device of claim 1, wherein the first and second attachment components have the same shape.

3. The device of claim 1, wherein the first and second attachment components have a different shape than one another.

4. The device of claim 1, wherein the first and second attachment components have at least one through slot that allows the webbing strap to be pulled therethrough.

5. The device of claim 4, wherein the third of the attachment components has at least one slot in the movable piece that allows the webbing strap to be pulled therethrough.

6. The device of claim 1, wherein the third of the attachment components has at least one slot in the movable piece that allows the webbing strap to be pulled therethrough.

7. The device of claim 6, wherein the first and second attachment components have at least one through slot that allows the webbing strap to be pulled therethrough.
